(19) United States
(12) Patent Application Publication
(10) Pub. No.: US 2026/0326503 A1
(43) Pub. Date: Oct. 22, 2026

(54) VALVE FOR INTEGRATED THERMAL MANAGEMENT SYSTEM OF A VEHICLE

(71) Applicant: L&T TECHNOLOGY SERVICES LIMITED, Chennai (IN)

(72) Inventors: SAIKRISHNA SRIDHAR, Chennai (IN); MUTHUKRISHNAN KAILAPERUMAL, Thanjavur (IN)

(21) Appl. No.: 19/570,216

(22) Filed: Mar. 18, 2026

(30) Foreign Application Priority Data
Apr. 15, 2025 (IN) 202541036494

(51) Int. Cl. B60H 1/00; B60L 58/24; F16K 11/076; F16K 31/02

(52) U.S. Cl. CPC B60H 1/00885; B60H 1/00278; B60H 1/00385; B60L 58/24; F16K 11/076; F16K 31/025; B60H 2001/00307; B60H 2001/00942; B60L 2240/545

(57) ABSTRACT

A valve for integrated thermal management of a vehicle is disclosed. The valve comprises a housing (10) with a plurality of ports (40). A rotatable body (20) within consists of multiple sections (22a, 22b, 22c, 22d), each with passages (24) that define a network of fluid connections. An actuator (30) is housed within the valve, controls the rotation of the body (20). A plurality of sensors (50), connected to the actuator and the vehicle, detect ambient temperature and operating conditions. A control unit (60) is communicatively connected to the actuator (30) and sensors (50), to determine operating states and adjusts the actuator (30) to establish the necessary fluid connections between selected ports (40). This adaptive valve operation optimizes thermal management, enhancing efficiency and vehicle performance.

### TECHNICAL FIELD

Present disclosure relates to a field of thermal management systems for automobiles. More particularly, aspects of the present disclosure relates to a valve for integrated thermal management system of a vehicle.

### BACKGROUND

Thermal management is a crucial aspect of electric vehicle (EV) performance, ensuring optimal operation of an electric powertrain, a battery, and a cabin heating system. Conventionally in EVs, these thermal systems operate independently, leading to inefficiencies. Few of the inefficiencies include that independent operation may result in inefficient heat distribution, where some components overheat while others components may remain underutilized. Further, each thermal system consumes energy separately, increasing an overall power demand from the battery. One of the inefficiency also include, each subsystem of the thermal systems having separate cooling loops, pumps, and heat exchangers, resulting in redundant components and increased energy consumption. Additionally, there are limitations to the system to efficiently collect and reuse waste heat generated from the electric powertrain and battery, leading to higher power demand for cabin heating, ultimately reducing driving range and vehicle operation. In extreme conditions, these conventional non-integrated thermal management systems fail to maintain consistent temperature control, affecting battery performance and passenger comfort.

To address these limitations and inefficiencies, recent development in the EVs introduced semi-integrated thermal management systems using three-way valves to interconnect cooling loops. This advancement allowed for partial heat reuse, where waste heat from the electric powertrain and battery could be redirected to the cabin, improving overall efficiency. This also aided in optimizing cooling performance, ensuring improved temperature regulation of the battery and electric powertrain components. However, this semi-integration came with new challenges and limitations, including increased complexity of fluid connections due to additional three-way valves, leading to increased manufacturing costs. One of the major drawback of these systems is component duplication, as they still require multiple pumps, heat exchangers, and control units to manage heat flow effectively. The integration of multiple thermal circuits through additional valves and pipes results in complex layout of the thermal management system, requiring additional maintenance costs and frequent repairs or replacements of the components. Furthermore, additional fluid connections or routings increases pressure losses, effecting cooling efficiency and system reliability. Subsequently, due to continuous operation of these conventional systems with additional fluid connection create potential failure points, increasing a risk of leaks or malfunctions. Although the conventional thermal management systems provide few advancements, they have significant limitations in efficiency, cost, and reliability. While partial heat reuse has improved energy utilization, the additional components assembly and complex fluid connections increase manufacturing costs and system weight, effecting overall vehicle efficiency.

Therefore, there exists a need to develop a centralized valve for a thermal management system to seamlessly integrate electric powertrain, battery, and cabin heating circuits while reducing system complexity, component redundancy, and energy losses. The present disclosure is directed to overcome one or more limitations stated above or any other limitations associated with the prior art. The information disclosed in this background of the disclosure section is only for enhancement of understanding of the general background of the invention and should not be taken as an acknowledgement or any form of suggestion that this information forms the prior art already known to a person skilled in the art.

### SUMMARY OF THE INVENTION

In an embodiment, a valve for an integrated thermal management system of a vehicle is disclosed.

The valve comprises a housing, defined with an opening and the housing is having a plurality of ports formed therein. A body is rotatably disposed within the opening. The body comprises a plurality of sections and each section includes a plurality of passages configured to define a network of fluid connections among a plurality of ports. An actuator is disposed within the housing and coupled to the body. The actuator is configured to selectively control the rotation of the body (20). Further, a plurality of sensors are connected to the actuator to the vehicle. The plurality of sensors is configured to detect operating conditions based on an ambient temperature and a vehicle operating state. A control unit is communicatively coupled with actuator and the plurality of sensors. The control unit is configured to determine the ambient temperature and the vehicle operating state based on inputs received from the plurality of sensors. The control unit is further configured to activate the actuator to rotate the body and establish the fluid connections between selected ports among the plurality of ports, based on real time operating conditions derived from the ambient temperature and vehicle operational state.

In an embodiment, the plurality of ports comprises a plurality of inlet ports and plurality of outlet ports. The plurality of inlet ports is configured to receive a coolant from a plurality of components of a thermal management system. Each inlet port of the plurality of inlet ports is in fluid communication with at least one of an electric powertrain, a radiator, a battery, and a cabin heater of the thermal management system to receive the coolant. Further, the plurality of outlet ports is configured to direct and supply the coolant to the plurality of components of the thermal management system such that each outlet port of the plurality of outlet ports is in fluid communication with at least one of the radiator, a refrigerant chiller for the battery, the electric powertrain, and a water heater of the thermal management system.

In an embodiment, the plurality of inlet ports and the plurality of outlet ports comprise a first inlet port to receive a coolant from the electric powertrain of the vehicle and a second inlet port to receive the coolant from the radiator of the vehicle. Further, a third inlet port is provided to receive the coolant from the battery of the vehicle and a fourth inlet port to receive the coolant from the cabin heater of the vehicle. The outlet ports include a first outlet port to direct and supply the coolant to the radiator. A second outlet port directs and supplies the coolant to the refrigerant chiller fluidly connected to the battery of the vehicle through a first pump. A third outlet port directs and supplies the coolant to the electric powertrain through a second pump and a fourth outlet port directs and supplies the coolant to a water heater fluidly connected to the cabin heater of the vehicle through a third pump.

In an embodiment, the operating conditions comprise a first operating condition with the ambient temperature in range of −20 °C to 0 °C and the vehicle operational state is in at least one of a charging and stationary state. In the first operating condition the control unit is configured to activate the actuator to rotate the body to position a first section of the plurality of to align with the plurality of ports to establish fluid connections between the third inlet port to the fourth outlet port and between the fourth inlet port to the second outlet port, to heat the battery and the cabin heater using the water heater, when the refrigerant chiller is turned off.

In an embodiment, the operating conditions comprise a second operating condition with the ambient temperature in range of −20 °C to 0 °C and the vehicle operational state in a running state with temperature of the electric powertrain below 80 °C. In the second operating condition, the control unit is configured to activate the actuator to rotate the body to position the first section for establishing fluid connections between the first inlet port with the third outlet port; between the third inlet port with the fourth outlet port, and; between the fourth inlet port with the second outlet port, for heating of the battery and the cabin heater using the water heater, and for recirculation of the coolant within the electric powertrain, when the refrigerant chiller is turned off.

In an embodiment, the operating conditions comprise a third operating condition with the ambient temperature in range of −20 °C to 0 °C and the vehicle operational state in a running state with temperature of the electric powertrain nearly 80 °C. In the third operating condition the control unit is configured to activate the actuator to rotate the body to position a second section of the plurality of section to align with the plurality of ports for establishing fluid connections between; the first inlet port and the second inlet port with the second outlet port; between the fourth inlet port with the fourth outlet port and; between the third inlet port with the third outlet port to heat the battery by supplying the coolant from the electric powertrain, and to heat the cabin heater by the water heater, when the refrigerant chiller is turned off.

In an embodiment, the operating conditions comprise a fourth operating condition with the ambient temperature in range of 0 °C to 20 °C. In the fourth operating condition the control unit is configured to activate the actuator to rotate the body to position a third section of the plurality of section to align with the plurality of ports for establishing fluid connections between the first inlet port with the first outlet port; between the second inlet port with the second outlet port; between the third inlet port to the third outlet port, and between the fourth inlet port to the fourth outlet port, to facilitate the cooling of the battery and the electric powertrain by the radiator, and heating of the cabin heater by the water heater, when the refrigerant chiller is turned off.

In an embodiment, the operating conditions comprise a fifth operating condition with the ambient temperature more than 20 °C, the vehicle operational state in a running state with temperature of the battery is nearly 40 °C. In the fifth operating condition the control unit is configured to activate the actuator to rotate the body to the second section for establishing fluid connections between the first inlet port and the second inlet port to the second outlet port; between the fourth inlet port to the fourth outlet port, and between the third inlet port with the third outlet port to cool the battery and the electric powertrain by the refrigerant chiller, and further for cooling of a cabin of the vehicle by supplying the refrigerant from an evaporator, when the third pump is turned off.

In an embodiment, the operating conditions comprise a sixth operating condition with the ambient temperature more than 20 °C, the vehicle operational state in a running state with temperature of the battery is nearly 40 °C. In the sixth operating condition the control unit is configured to activate the actuator to rotate the body to position a fourth section of the plurality of sections to align with the plurality of ports for establishing fluid connections between the first inlet port to the first outlet port; between the second inlet port to the third outlet port, between the third inlet port to the second outlet port, and between the fourth inlet port to the fourth outlet port, to cool the electric powertrain by the radiator, cool the battery by the refrigerant chiller, and further to cool the cabin of the vehicle by supplying refrigerant from the evaporator, when the third pump is turned off.

In an embodiment, the valve comprises a cover removably coupled to the housing for enclosing the opening.

The present disclosure further discloses an integrated thermal management system for a vehicle comprising a valve. The valve includes a housing, defined with an opening and the housing is having a plurality of ports formed therein. A body is rotatably disposed within the opening. The body comprises a plurality of sections and each section includes a plurality of passages configured to define a network of fluid connections among a plurality of ports. An actuator is disposed within the housing and coupled to the body. The actuator is configured to selectively control the rotation of the body (20). Further, a plurality of sensors are connected to the actuator to the vehicle. The plurality of sensors is configured to detect operating conditions based on an ambient temperature and a vehicle operating state. A control unit is communicatively coupled with actuator and the plurality of sensors. The control unit is configured to determine the ambient temperature and the vehicle operating state based on inputs received from the plurality of sensors. The control unit is further configured to activate the actuator to rotate the body and establish the fluid connections between selected ports among the plurality of ports, based on real time operating conditions derived from the ambient temperature and vehicle operational state.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1a illustrates an exploded view of a valve for a thermal management system, in accordance with an embodiment of the present disclosure;

FIG. 1b illustrates a perspective view of valve in assembled condition of FIG. 1a, in accordance with an embodiment of the present disclosure

FIG. 2a illustrates a front view of the valve in the assembled condition of FIG. 1b, in accordance with an embodiment of the present disclosure;

FIG. 2b illustrates a perspective view of a body of the valve, in accordance with an embodiment of the present disclosure;

FIG. 2c illustrates a block diagram with the valve and the thermal management system, in accordance with an embodiment of the present disclosure;

FIG. 3 illustrates a schematic view of the thermal management system having the valve of Figure la, in accordance with an embodiment of the present disclosure;

FIG. 4a illustrates a schematic view of the thermal management system with the valve in a first operating condition and a second operating condition, in accordance with an embodiment of the present disclosure;

FIG. 4b and FIG. 4c illustrate a front view of the valve defined for the first operating condition and the second operating condition, in accordance with an embodiment of the present disclosure;

FIG. 5a illustrates a schematic view of the thermal management system with the valve in a third operating condition, in accordance with an embodiment of the present disclosure;

FIG. 5b illustrates a front view of the valve defined with the second section positioned for the third operating condition, in accordance with an embodiment of the present disclosure;

FIG. 6a illustrates a schematic view of the thermal management system with the valve in a fourth operating condition, in accordance with an embodiment of the present disclosure;

FIG. 6b illustrates a front view of the valve defined with the third section positioned for the third operating condition, in accordance with an embodiment of the present disclosure;

FIG. 7a illustrates a schematic view of the thermal management system with the valve in a fifth operating condition, in accordance with an embodiment of the present disclosure;

FIG. 7b illustrates a front view of the valve defined with the second section positioned for the fifth operating condition, in accordance with an embodiment of the present disclosure;

FIG. 8a illustrates a schematic view of the thermal management system with the valve in a sixth operating condition, in accordance with an embodiment of the present disclosure;

FIG. 8b illustrates a front view of the valve defined with the fourth section positioned for the sixth operating condition, in accordance with an embodiment of the present disclosure;

### DETAILED DESCRIPTION OF THE DRAWINGS

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the scope of the disclosed embodiments. It is intended that the following detailed description be considered as exemplary only, with the true scope being indicated by the following claims. Additional illustrative embodiments are listed.

It is to be noted that a person skilled in the art would be motivated from the present disclosure and modify construction of a valve for a thermal management system of a vehicle. However, such modifications should be construed within the scope of the present disclosure. Accordingly, the drawings show only those specific details that are pertinent to understand the embodiments of the present disclosure, so as not to obscure the disclosure with details that will be readily apparent to those of ordinary skill in the art having benefit of the description herein.

The terms “comprise,” “comprising,” or any other variations thereof used in the disclosure, are intended to cover a non-exclusive inclusion, such that a system and method that comprises a list of components does not include only those components but may include other components not expressly listed or inherent to such system, method, or assembly, or device. In other words, one or more elements in a system or device proceeded by “comprises . . . a” does not, without more constraints, preclude the existence of other elements or additional elements in the system or device.

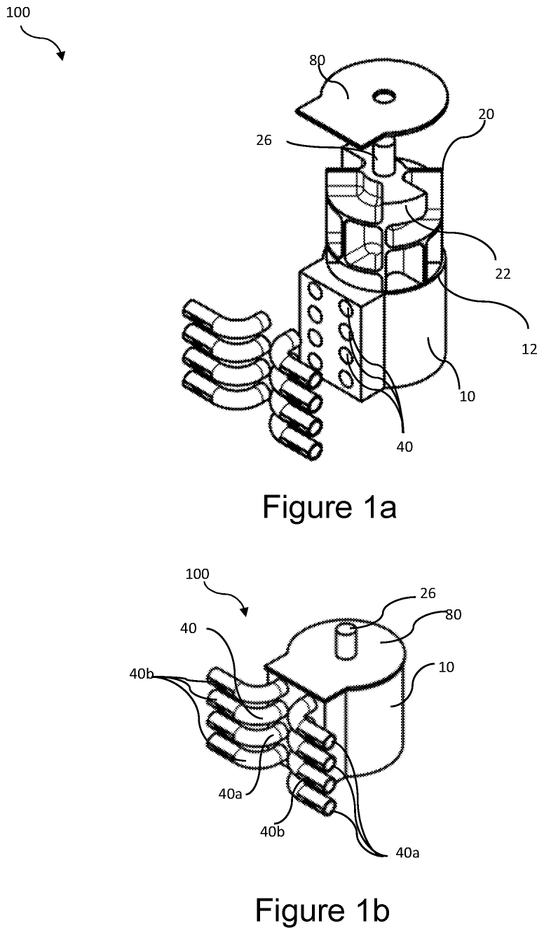

The following paragraphs describe the present disclosure with reference to FIG. 1a to FIG. 8b. In the figures, the same element or elements which have similar functions are indicated by the same reference signs.

Referring to Figure 1a to 8b, which are exemplary embodiments of the present disclosure illustrating a valve (100) for a thermal management system (200) [alternatively referred as the “system (200)”] of a vehicle [not specifically shown in Figures].

The following detailed description is merely exemplary in nature and is not intended to limit application and uses. Furthermore, there is no intention to be bound by any theory presented in the preceding background or summary or the following detailed description. It is to be understood that the disclosure may assume various alternative orientations and step sequences, except where expressly specified to the contrary. It is also to be understood that the specific devices or components illustrated in the attached drawings and described in the following specification are simply exemplary embodiments of the inventive concepts defined in the appended claims. Hence, specific dimensions or other physical characteristics relating to the embodiments that may be disclosed are not to be considered as limiting, unless the claims expressly state otherwise. Hereinafter, preferred embodiments of the present disclosure will be described referring to the accompanying drawings. While some specific terms of “upper,” “lower,” “below,” “above,” “right,” “left,” “rear” or “front” and other terms containing these specific terms and directed to a specific direction will be used, the purpose of usage of these terms or words is merely to facilitate understanding of the present invention referring to the drawings. Accordingly, it should be noted that the meanings of these terms or words should not improperly limit the technical scope of the present invention.

Also, it is to be understood that the phraseology and terminology used herein is for description and should not be regarded as limiting. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings. It is to be understood that this disclosure is not limited to the specific devices, methods, applications, conditions, or parameters described and/or shown herein and that the terminology used herein is to describe particular embodiments by way of example and is not intended to be limiting of the claimed invention. Hereinafter in the following description, various embodiments will be described. For purposes of explanation, specific configurations and details are outlined to provide a thorough understanding of the embodiments. However, it will also be apparent to one skilled in the art that the embodiments may be practiced without the specific details. Furthermore, well-known features may be omitted or simplified in order not to obscure the embodiment being described.

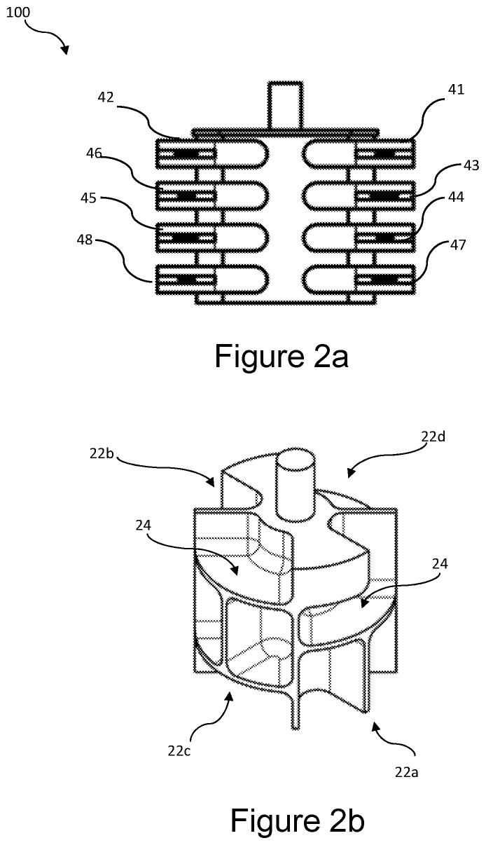

Referring to FIGS. 1 to 2b in conjunction, which illustrates various views of a valve (100) comprises a housing (10) defined with an opening (12). The housing (10) is a structural component of the valve (100), configured for enclosing and supporting internal components of the valve (100). Further, the valve (100) comprises a body (20) rotatably disposed within the opening (12) of the housing (10). This body (20) is positioned and receivable in the opening (12) of the housing (10). The housing (10) is structured to provide protection for the internal components while ensuring proper alignment and stability of the functional elements within the valve (100). The body (20) may be configured to move rotatably within the housing (10). In an embodiment, a substantially central portion of the housing (10) is defined with the opening (12) to receive the body (20).

Further, the body (20) may be disposed around an elongated shaft (26) such that a rotation of the elongated shaft (26) results in rotation of the body (20) with the housing (10). In an embodiment, the elongated shaft (26) may be connected to a top portion of the body (20) and rotation of the elongated shaft (26) results in rotation of the body (20). The elongated shaft (26) connected to the body (20) may be securely mounted within the housing (10) to maintain stability and prevent unwanted displacement, thereby contributing to a precise operation of the valve (100). In an embodiment, the valve (100) comprises a cover (80) removably coupled to the housing (10) for enclosing the opening (12).

Referring to FIGS. 2a and 2b, the body (20) comprises a plurality of sections (22). Each section (22a, 22b22c,22d) of the body (20) is defined with a plurality of passages (24) configured to define a network of fluid connections. The housing (10) comprises a plurality of ports (40) therein, and each port of the plurality of ports (40) is fluid communication with the plurality of passages (24) defined at each section (22a, 22b22c,22d) of the body (20). In an embodiment, the plurality of ports (40) may align with the plurality of passages (24) defined in each section (22a, 22b22c,22d) of the body (20) as seen in FIG. 2a.

Referring to FIGS. 1b and 2a, the valve (100) having plurality of ports (40) comprises a plurality of inlet ports (40a) and a plurality of outlet ports (40b). The plurality of inlet ports (40a) receive a coolant from a plurality of components of the thermal management system (200). Further, each inlet port of the plurality of inlet ports (40a) is in fluid communication with at least one of an electric powertrain (201), a radiator (202), a battery (203), and a cabin heater (204) of the thermal management system (200) to receive the coolant. Also, the plurality of outlet ports (40b) is configured to direct and supply the coolant to the plurality of components of the thermal management system (200). Each outlet port of the plurality of outlet ports (40b) is in fluid communication with at least one of the radiator (202), a refrigerant chiller (REF LLC) (205) for the battery (203), the electric powertrain (201), and a water heater (207) of the thermal management system (200). In an embodiment, the radiator (202) may be a low temperature radiator.

More particularly, the plurality of inlet ports (40a) and plurality of outlet ports (40b) further includes a first inlet port (41) to receive the coolant from the electric powertrain (201) of the vehicle. In one of operating condition, the electric powertrain (201) of the system (200) may include an electric motor, inverter, and power electronics [not specifically shown in figures], that generate substantial heat during operation. The coolant is configured to absorb the heat from the electric powertrain (201) and enter the first inlet port (41) and this heated coolant may be directed for cooling through the valve (100) to other components of the system (200). Further, a second inlet port (43) is provided to receive the coolant from the radiator (202) of the vehicle. In an operating condition, the radiator (202) may dissipate excess heat from the coolant by transferring the coolant to the ambient air. The cooled coolant exiting the radiator (202) may enter the valve (100) through the second inlet port (43), wherein this received coolant is redirected to other components of the system (200). A third inlet port (45) is provided in the valve (100) to receive the coolant from the battery (203) of the vehicle. The battery (203) of the system (200) requires precise temperature regulation to maintain efficiency. Thus, after circulating the coolant through the battery (203), the coolant may enter the valve (100) through the third inlet port (45) for further temperature regulation or redistribution to other components of the system (200). A fourth inlet port (47) is provided to receive the coolant from the cabin heater (204) of the vehicle. In an embodiment, the cabin heater (204) is configured to utilize a heated coolant to provide warmth to the passenger cabin. Once the heat is transferred, the coolant is configured to enter the valve (100) through the fourth inlet port (47) before being distributed to other components of the system (200).

Additionally, referring to FIGS. 1b and 2a the plurality of outlet ports (40b) include a first outlet port (42), a second outlet port (44), a third outlet port (46) and a fourth outlet port (48). The first outlet port (42) is configured to direct and supply the coolant to the radiator (202). In one of the operating conditions, when the system (200) determines excess heat to be dissipated, the coolant may be directed from the valve (100) to the radiator (202) through the first outlet port (42). The radiator (202) is configured to cool the coolant by transferring heat to the ambient air before recirculating to the valve (100). Further, a second outlet port (44) is provided to direct and supply the coolant to the chiller (205) fluidly connected to the battery (203) of the vehicle through a first pump (210).

In one of the operating conditions, the battery (203) be maintained at an optimal temperature range for efficiency and safety of the vehicle. In one of the operating condition, when additional cooling is required, the coolant may be directed from the valve (100) through the second outlet port (44) to the refrigerant chiller (205) via the first pump (210). The refrigerant chiller (205) may refrigerant-based cooling to lower the coolant temperature before recirculating the coolant to the battery (203).

The valve (100) also includes a third outlet port (46) to direct and supply the coolant to the electric powertrain (201) through a second pump (212). In an embodiment, to prevent overheating of the electric power train (201), the coolant may be supplied to the electric powertrain (201) through the third outlet port (46). Further, the second pump (212) ensures proper flow and circulation of the coolant to the components of the electric powertrain (201). The valve (100) includes a fourth outlet port (48) to direct and supply the coolant to the water heater (207) fluidly connected to the cabin heater (204) of the vehicle through a third pump (213). In one of the operating configurations, requiring heating of the passenger cabin, the coolant may be directed and routed from the valve (100) to the water heater (207) via the fourth outlet port (48). The third pump (213) facilitates the circulation of coolant to the cabin heater (204), ensuring optimal passenger comfort.

Referring to Figure la and FIG. 2c, the valve (100) comprises an actuator (30). The actuator (30) is disposed within the housing (10) and coupled to the body (20). In an embodiment, the actuator (30) may be coupled to the elongated shaft (26) which facilitates in rotation of the body (20). The actuator (30) is configured to selectively control the rotation of the body (20) when activated. The actuator (30) may be configured for the rotational movement of the body (20) about the housing (10). Therefore, the actuator (30) aids in aligning the plurality of passages (24) of each section (22a, 22b22c,22d) of the body (20) with the required plurality of ports (40) to establish the desired fluid flow connection. In an embodiment, the actuator (30) may be at least one of electromechanical actuator such as a DC motor or stepper motor, a solenoid actuator or a piezoelectric or smart material-based actuators.

Referring to FIG. 2c, the valve (100) further comprises a plurality of sensors (50). The plurality of sensors (50) is communicatively coupled with the actuator (30). Further, the plurality of sensors (50) is coupled to the vehicle. Thus, the plurality of sensors (50) coupled to the vehicle is configured to detect operating conditions based on ambient temperature and vehicle operating state. The plurality of sensors (50) are configured to continuously monitor environmental and vehicle operating conditions. In an embodiment, plurality of sensors (50) may be strategically positioned within components of the vehicle and the thermal management system (200) of the vehicle. Further, the plurality of sensors (50) are communicatively linked to the actuator (30) and a control unit (60). The plurality of sensors (50) may be at least one of ambient temperature sensors, coolant temperature sensor, to detect external temperature conditions to optimize thermal regulation and monitor the temperature of the coolant circulating through the system (200). Further, the plurality of sensors (50) may include vehicle operating sensors which may be at least one of engine load sensors, speed sensors, and battery temperature sensors, which help determine the vehicle's operational state. By collecting real-time data, the plurality of sensors (50) ensure that the valve (100) operates optimally to regulate fluid flow according to thermal requirements of the system (200).

In an embodiment, the plurality of sensors (50) may be provided at the vehicle to detect ambient temperature i.e., external environment conditions. Further, the plurality of sensors (50) may be provided at various component locations in the system (200) to detect a coolant temperature. Also, the plurality of sensors (50) detects the temperature of the battery (203) and the temperature of the electric powertrain (201) of the vehicle to ensure optimal performance. Additionally, the plurality of sensors (50) are provided in the vehicle to detect operating state which may be driving mode, speed, acceleration, and load acting on the electric powertrain (201) and the battery (203).

Further, the valve (100) comprises the control unit (60) is communicatively coupled with actuator (30), and the plurality of sensors (50). The control unit (60) is configured to determine the ambient temperature and the vehicle operating state based on inputs received from the plurality of sensors (50). Subsequently, the control unit (60) is configured to activate the actuator (30) to rotate the body (20) of the valve (100). This aids in establishing the fluid connections between selected ports among the plurality of ports (40), based on real time operating conditions derived from the ambient temperature and vehicle operational state from the plurality of sensors (50). The control unit (60) is configured to process the inputs and data received from plurality of sensors (50) in real-time. Based on the analysis of the inputs and data, the control unit (60) determines the optimal coolant flow path to achieve required operation condition of the valve (100) of the system (200). The control unit (60) may activate or deactivate flow of the coolant within the system (200). The control unit (60) is communicatively coupled with the actuator (30) to rotate and position the body (20) of the valve (100) to a required section (22a, 22b22c,22d) based on the input received regarding the operating state. Additionally, the control unit (60) may be communicatively coupled with the first pump (210), the second pump (212) and the third pump (213) to ensure the coolant circulation through the valve (100) and components of the system (200).

In an embodiment, the control unit (60) may be integrated into a controller (220) of the vehicle. This controller (220) serves as a primary controller to operate vehicle subsystems, including the system (200). The controller (220) continuously monitors real-time data from plurality of sensors (50) to assess the operating conditions of critical components such as the electric powertrain (201), the battery (203), the radiator (202), and the cabin heating system. By analyzing inputs related to temperature of electric powertrain (201), a coolant flow rate, ambient temperature and condition, and a vehicle speed, the controller (220) determines the required cooling or heating adjustments necessary for optimal performance of the vehicle. The control unit (60) of the valve (100) aids in maintaining a constant communication with the controller (220), providing feedback on position of the valve (100), coolant flow status, and operating state of the vehicle and the system (200).

The control unit (60) and the controller (200) may further comprise, a processor and a memory unit and are communicatively coupled to the processor. The processors can be implemented as one or more microprocessors, microcomputers, microcontrollers, digital signal processors, central processing units, state machines, logic circuitries, and/or any devices that manipulate signals based on operational instructions. The memory unit stores processor-executable instructions, which, on execution, causes the processor to receive one or more command signals associated with the user inputs from a user interface unit [not shown in Figures] or control panel of the vehicle and the plurality of sensors (50) of the vehicle and components of the system (200). In an embodiment, user interface can be an input/output device to display graphical information related to system (200) to facilitate controlling of the position of the valve (100).

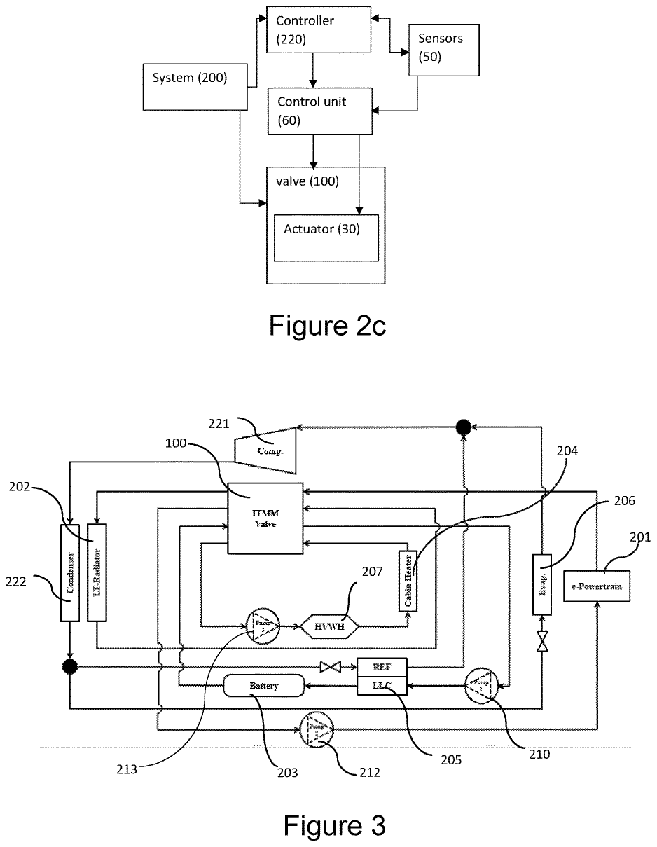

Referring to FIG. 3, the integrated thermal management system (200) is depicted which integrates the coolant circuits for the electric powertrain (201), battery (203), and cabin heating by the valve (100). This system (200) optimizes the distribution of thermal energy using a combination of refrigerant and coolant loops, ensuring efficient heat dissipation and thermal regulation for vehicle subsystems. The primary function of the valve (100) is to control the direction and flow rate of the coolant to different components based on real-time operating conditions. This integration is critical for maintaining optimal operating temperatures for the electric powertrain (201), battery (203), and passenger cabin while maximizing energy efficiency and reducing thermal losses.

The coolant circuit consists of components, including the electric powertrain (201), a water heater (WH) (207), a battery cooling loop, the cabin heater (204), a low-temperature radiator (LT-radiator) (202), and pumps (212, 210, 203) to regulate coolant circulation. In an embodiment, the water heater (207) may be high voltage water heater (HVWH). The valve (100) dynamically distributes coolant to the components based on heat generation and dissipation needs. For example, excess heat from the electric powertrain (201) can be redirected to warm the cabin or precondition the battery (203). The battery thermal management loop operates independently but remains integrated with the overall system, utilizing a pump and a heat exchanger to maintain the battery (203) within an optimal temperature range, ensuring reliable performance.

In an embodiment, as seen in FIG. 3, the refrigerant loop is closely integrated with the coolant system and consists of a compressor (221), a condenser (222), an evaporator (206), and a refrigerant chiller (REF LLC) (205). The compressor (221) pressurizes and circulates the refrigerant, facilitating heat exchange with the coolant circuit through dedicated heat exchangers. The condenser (222) releases heat to the environment via the radiator (202), while the evaporator (206) absorbs heat from the cabin or other components, assisting in cooling. This dual-loop integration allows for precise thermal management, where refrigerant-based cooling supports peak load conditions, and coolant-based circulation ensures steady-state thermal equilibrium. The cabin heater (204) can utilize waste heat from the electric powertrain (201) or actively draw heat from the water heater (207), enhancing passenger comfort.

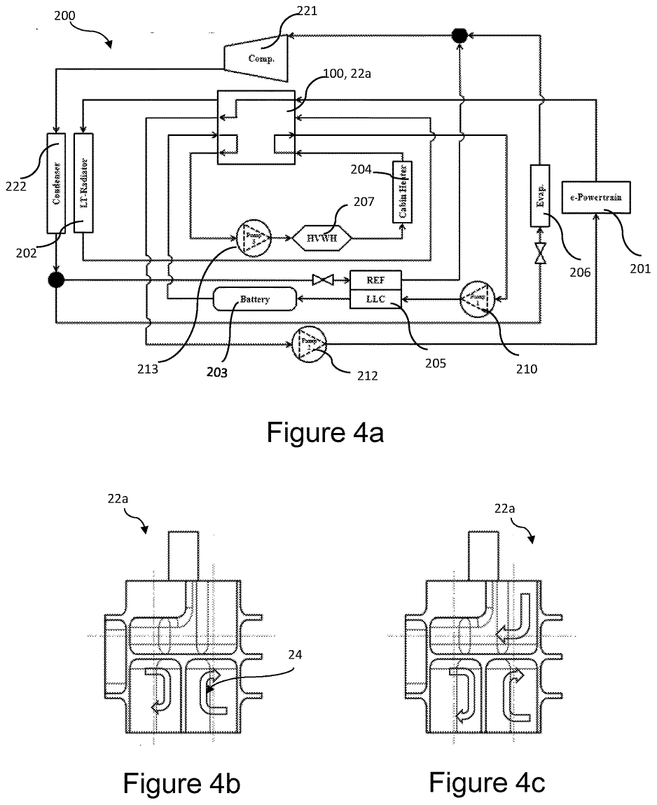

Referring to FIGS. 4a and 4b, the operating condition includes a first operating condition. The first operating condition includes the ambient temperature ranging from −20°C to 0 °C, and the vehicle is in a charging or stationary state. The system (200) is activated a specific heating operation to ensure optimal battery and passenger cabin temperatures. The control unit (60), based on real-time inputs received from the plurality of sensors (50), activates the actuator (30) to rotate the body (20) of the valve (100) to position a first section (22a) of the plurality of sections (22) to align with the plurality of ports (40) to establish fluid connections.

During this first operating condition, the control unit (60) positions the first section (22a) of the valve (100) to align with the designated plurality of ports (40) to facilitate the heating process as seen in FIG. 4b. The fluid connection is established between the third inlet port (45) to the fourth outlet port (48). More specifically, the third inlet port (45) is configured to receive the coolant from the battery (203), and the control unit (60) is configured to direct this coolant through the fourth outlet port (48) to the water heater (207) using the third pump (213). The water heater (207) aids in raising the coolant temperature before circulating the coolant back to the battery (203) to maintain performance of the battery (203) in cold weather via the plurality of pathways (24) defined in the first section (22a).

Also, the fluid connection is established between the fourth inlet port (47) to the second outlet port (44), to heat the battery (203) and the cabin heater (204) using the water heater (207). More particularly, the fourth inlet port (47), receives the coolant from the cabin heater (204), connected to the second outlet port (44) and is pumped by the first pump (210) towards the refrigerant chiller (205), although the refrigerant chiller (205) is deactivated during this mode to prevent unnecessary cooling. The third pump (213) ensures that warm coolant is efficiently delivered from the water heater (207) to the battery (203), maintaining an optimal operating temperature and improving battery (203) efficiency. Meanwhile, the first pump (210) facilitates the circulation of coolant from the cabin heater (204) towards the refrigerant chiller (205) which remains off, ensuring that excess heat is retained for passenger cabin heating. The second pump (212) is not actively engaged, since cooling for the electric powertrain (201) is a secondary function and requirement in this first operating condition. Therefore, by selectively directing the coolant through the valve (100), the system (200) minimizes energy consumption while maintaining necessary thermal conditions. The result to deactivate and turn off the refrigerant chiller (205) prevents unnecessary cooling, ensuring that available thermal energy to be directed toward heating. This efficient regulation optimizes vehicle performance and enhances the driving experience during extreme cold conditions.

Additionally, referring to FIG. 4a and FIG. 4c, a second operating condition is illustrated wherein the ambient temperature is in range of −20 °C to 0 °C and the vehicle operational state in a running state with temperature of the electric powertrain (201) nearly 80 °C. In an embodiment, in the vehicle operational state, specifically in the running state the temperature of the electric powertrain (201) may be below 80 °C. The second operating condition specifically facilitates in maintaining optimal temperatures for both the electric powertrain (201) and the battery (203), ensuring efficient performance when the temperature of the electric powertrain (201) nearly 80 °C. The system (200) is configured to dynamically regulates coolant flow using the valve (100), which is controlled by the actuator (30) based on real-time inputs received from the plurality of sensors (50). The control unit (60) is configured to activate the actuator (30) to rotate the body (20) to position the first section (22a) for establishing fluid connections.

The fluid connection is established between the first inlet port (41) with the third outlet port (46). More particularly, the coolant from the electric powertrain (201) is received through the first inlet port (41) and directed to the third outlet port (46), enabling coolant circulation within the powertrain (201) via the second pump (212). This recirculation helps maintain optimal operating temperatures without engaging the refrigerant chiller (205), thus conserving energy. Simultaneously, the battery (203) requires heating to ensure functioning in low-temperature conditions. The coolant from the battery (203) enters the valve (100) through the third inlet port (45) and is directed to the fourth outlet port (48), allowing the heated coolant to flow into the water heater (207). The third pump (213) ensures adequate circulation of warm coolant between the water heater (207) and the battery (203). Additionally, the coolant from the cabin heater (204) is directed through the fourth inlet port (47) and exits through the second outlet port (44), ensuring the heating of the passenger cabin using a heat exchanger [not specifically shown in Figures]. This configuration of the valve (100) and the system (200) ensures passenger comfort while maintaining optimal temperature of the battery (203), ultimately enhancing the operation of the vehicle's electric powertrain (201) in cold conditions.

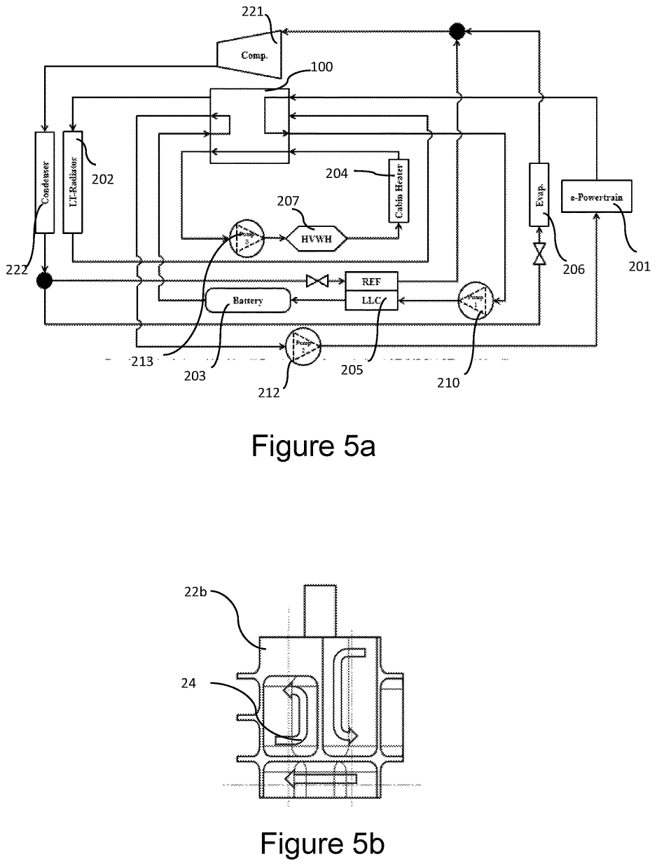

Referring to FIGS. 5a and 5b, a third operating condition is illustrated, wherein the vehicle operates in an extremely cold ambient temperature range of −20 °C to 0 °C while the electric powertrain (201) temperature exceeds 80 °C. Under these conditions, the system (200) is configured to redistribute the excess heat from the electric powertrain (201) to warm both the battery (203) and the cabin heater (204), via the valve (100) to ensure optimal performance and passenger comfort in the passenger cabin. The control unit (60) is configured to determine the ambient conditions by the inputs received from the plurality of sensors (50) and activate the actuator (30). The actuator (20) rotates the body (20) such that the second section (22b) of the valve (100) aligns with the necessary plurality of ports (40), creating specific fluid connections to facilitate coolant and heat transfer as seen in FIG. 5b.

As seen in FIG. 5b, the fluid connection is established between the first inlet port (41) and the second inlet port (43) with the second outlet port (44). More particularly, the coolant from the electric powertrain (201) enters the valve (100) through the first inlet port (41), while the coolant from the radiator (202) enters via the second inlet port (43). The coolant received from both the first inlet port (41) and the second inlet port (43) are then directed to the second outlet port (44) to provide heat distribution. Further, the fluid connection is established between the fourth inlet port (47) with the fourth outlet port (48). In this fluid connection the coolant from the cabin heater (204) enters through the fourth inlet port (47) and is directed to the fourth outlet port (48), ensuring the water heater (207) supplies warm coolant back to the cabin heater (204), providing consistent heating. Also, the fluid connection is established between the third inlet port (45) with the third outlet port (46). The coolant from the battery (203) enters the valve (100) through the third inlet port (45) and is directed to the third outlet port (46). This process supplies the battery (203) with heated coolant from the electric powertrain (201), ensuring the battery (203) remains within an optimal operating temperature range.

Further, the second pump (212) actively circulates coolant between the powertrain (201) and the battery (203) to maintain the heat exchange. Further, for heating the passenger cabin, the third pump (213) facilitates the circulation of the coolant between the water heater (207) and the cabin heater (204), ensuring continuous supply of warm air into the passenger cabin. As the refrigerant chiller (205) remains turned off in this third operating condition, the heat is preserved rather than dissipated. This efficient thermal routing optimizes energy usage by utilizing the excess heat generated by the electric powertrain (201), reducing energy consumption while maintaining optimal temperature of the battery (203) and passenger cabin.

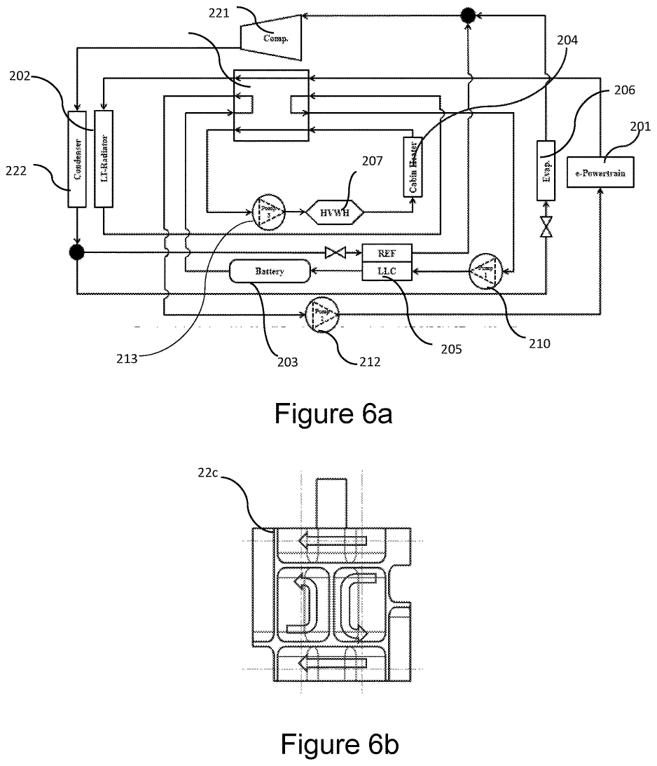

Referring to FIGS. 6a and 6b, a fourth operating condition wherein the ambient temperature is in range of 0 °C to 20 °C. In the fourth operating condition, the vehicle operates within a moderate ambient temperature range of 0 °C to 20 °C During this fourth operating condition state, the control unit (60) manages the coolant flow to cool the battery (203) and electric powertrain (201) using the radiator (202) while simultaneously heating the cabin heater (204) using the water heater (207). This ensures thermal efficiency without engaging the refrigerant chiller (205), for preserving energy.

The control unit (60) is configured to activate the actuator (30) to rotate the body (20) to position a third section (22c) of the plurality of section (22) to align with the plurality of ports (40) for establishing fluid connections as seen in FIG. 6b, The fluid connections is established between the first inlet port (41) with the first outlet port (42). More specifically, the electric powertrain (201) generates heat as the vehicle operates, requiring an effective cooling mechanism to prevent overheating. In this fourth operating condition, the control unit (60) adjusts the flow of the coolant by activating the actuator (30), which rotates the valve body (20) to align to the third section (22c) with specific plurality of pathways (24). The first inlet port (41) is linked to the first outlet port (42), enabling the coolant to absorb excess heat from the electric powertrain (201) and direct the coolant towards the radiator (202). The radiator (202) is configured to dissipates the heat into the surrounding air, maintaining a stable temperature of the electric powertrain (201). The first pump (210) ensures continuous coolant circulation between the electric powertrain (201) and the radiator (202), facilitating efficient heat transfer.

Further, in reference to FIG. 6b, the fluid connection is established between the second inlet port (43) with the second outlet port (44). In this fourth operating condition, the battery (203) also generates heat during charging and discharging cycles, necessitating the cooling loop to ensure long-term efficiency and safety. Thus, the second inlet port (43) is connected to the second outlet port (44), while the third inlet port (45) links to the third outlet port (46). These plurality of pathways in the third section (22c) of the valve (100) directs the coolant from the battery (203) to the radiator (202), where the excess heat is dissipated. The second pump (212) actively circulates the coolant, ensuring that the battery (203) remains within the optimal temperature range. This cooling prevents thermal runaway and enhances operational life of the battery (203).

While the radiator (202) controls cooling of the electric powertrain (201) and the battery (203), the passenger comfort is maintained using a separate heating circuit. The water heater (207) generates warm coolant, which is circulated to the cabin heater (204) through the fourth inlet port (47) and fourth outlet port (48). The third pump (213) facilitates the movement of warm coolant, ensuring sufficient heat supply for the passenger cabin. Therefore, in the fourth operating condition the refrigerant chiller (205) is turned off. As the ambient temperature is moderate and the refrigerant chiller (205) may be unnecessary to operate, and the system (200) instead relies on passive cooling of the radiator (202) and active water heating to manage thermal loads. This reduces energy consumption and enhances vehicle range while maintaining safe operating conditions.

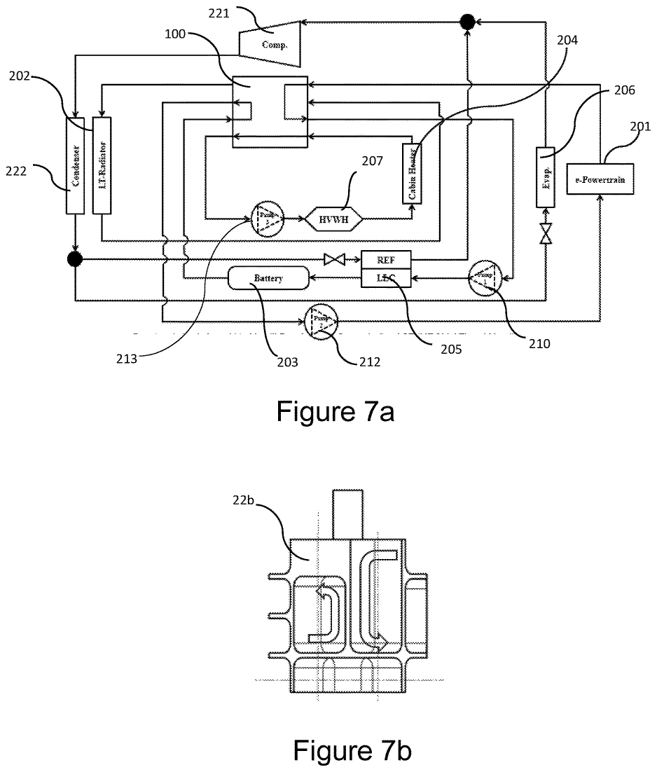

Referring to FIGS. 7a and 7b, a fifth operating condition is illustrated wherein the ambient temperature is more than 20 °C and the vehicle operational state in a running state with temperature of the battery (203) nearly 40 °C. In an embodiment, the vehicle operational state in the running state with temperature of the battery (203) may be below 40 °C. In this fifth operating condition, when the ambient temperatures exceeding 20 °C, the system (200) must efficiently regulate the temperatures of the battery (203), electric powertrain (201), and the passenger cabin. As the vehicle operates in the running state, heat generation from the battery (203) and electric powertrain (201) becomes significant. The system (100) must ensure that the temperature of the battery (203) remains nearly 40 °C to prevent degradation and maintain efficiency. To achieve this, the control unit (60) activates the actuator (30) to rotate the body (20) to the second section (22b) of the plurality of sections (22) for establishing fluid connections based on the inputs received from the plurality of sensors (50).

The fluid connection is established between the first inlet port (41) and the second inlet port (43) to the second outlet port (44). Also, the fluid connection is established between the third inlet port (45) to the third outlet port (46). The first inlet port (41) and the second inlet port (43) are connected to the second outlet port (44), forming the plurality of pathway (24) that facilitates the movement of coolant towards the refrigerant chiller (205). This allows the refrigerant chiller (205) to actively cool the circulating coolant before reaching the battery (203) and the electric powertrain (201). The first pump (210) is configured to circulates coolant between the electric powertrain (201) and the refrigerant chiller (205). Further, the third inlet port (45) is connected to the third outlet port (46), enabling efficient heat exchange as the coolant absorbs excess heat from the battery (203) before recirculating into the cooling loop. In an embodiment, the second pump (212) aids in supplying the coolant between the battery (203) and the refrigerant chiller (205), preventing overheating of the battery (203) and ensuring thermal stability.

In addition to maintaining optimal temperature of the battery (203) and electric powertrain (201), the system (200) with the valve (100) may also regulate the passenger cabin temperature for passenger comfort. Since ambient temperatures is more than 20 °C, the system (200) utilizes the refrigerant cycle rather than the coolant for effective passenger cabin cooling. The fourth inlet port (47) is connected to the fourth outlet port (48), to allow the evaporator (206) to receive the refrigerant. The evaporator (206) absorbs the heat from the passenger cabin air, effectively reducing the temperature inside the vehicle. Furthermore, the third pump (213) is turned off to prevent circulation of warm coolant.

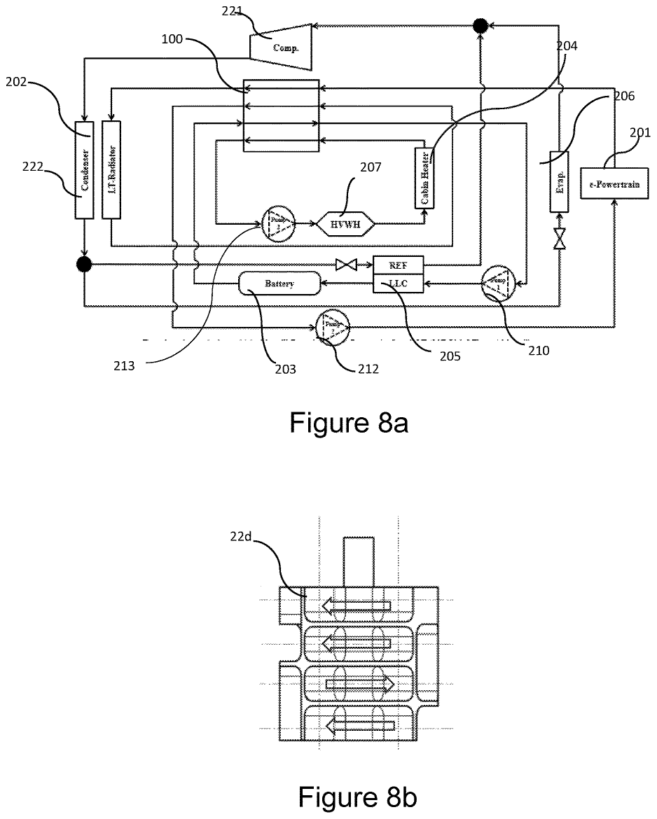

Referring to FIGS. 8a and 8b, a sixth operating condition is illustrated wherein the ambient temperature is more than 20 °C, and the vehicle operational state in a running state with temperature of the battery (203) nearly 40 °C. In an embodiment, the running state with temperature of the battery (203) is above 40 °C. More particularly, the electric powertrain (201) is actively engaged and unlike previous operating conditions, the primary function is that the battery (203) may exceed a critical temperature threshold of 40 °C. To prevent thermal runaway and ensure optimal performance, the system (200) and the valve (100) must be activated to cool the battery (203), electric powertrain (201), and the passenger cabin.

In the sixth operating condition the control unit (60) is configurated to activate the actuator (30) based on the inputs received from the plurality of sensors (50). The actuator (30) rotates the body (20) of valve (100) to position the fourth section (22d) in alignment with the corresponding plurality of ports (40) to establish fluid connections the first inlet port (41) to first outlet port (42). In this fluid connection, since the electric powertrain (201) generates significant heat during operation, this fluid pathway of the valve (100) directs the coolant toward the radiator (202), which facilitates heat dissipation into the ambient air. The radiator (202), being an air-cooled heat exchanger, ensures that excess heat from the electric powertrain (201) is efficiently removed, preventing overheating and maintaining optimal performance.

The fluid connection is established between the second inlet port (43) to third outlet port (46). This pathway (24) aids in managing the temperature of the battery (203). The coolant flows through the refrigerant chiller (205), which reduces the temperature of the battery (203) before redirecting into the valve (100). Further, the fluid connection between the third inlet port (45) to second outlet port ensures that the cooling loop remains efficient by redirecting the heated coolant from components of the system (200) towards the appropriate heat exchangers. This enables efficient thermal management by optimizing flow balance between different components. Similarly, the fluid connection between the fourth inlet port (47) to fourth outlet port (48) enables cabin cooling. The evaporator (206) maintains a desired temperature inside the cabin and the refrigerant absorbs heat from the cabin air, cooling before being cycled back into the refrigeration loop. This ensures that the passengers experience a comfortable interior temperature despite the increased ambient temperature.

In this sixth operating condition the first pump (201) ensures circulation of the coolant to the electric powertrain (201) and the radiator (202), allowing efficient heat dissipation. The second pump (212) supplies the coolant flow to the refrigerant chiller (205), which is configured for cooling the battery (203). Further, the third pump (213) in this sixth operating condition, remains turned off. Thus, any coolant flow dependent on the third pump (213) is bypassed.

In an embodiment, the valve (100) of the present disclosure is simple and compact to optimize space utilization within the vehicle. By integrating multiple fluid pathways into a single unit. Further, need for multiple individual valves and complex fluid networks is eliminated, leading to efficient packaging and better spatial arrangement in the system (200).

In another embodiment, the valve (100) of the present disclosure optimizes coolant flow and enhances waste heat recovery, ensuring that thermal energy from various vehicle components is effectively reused. This helps in improving the vehicle's range, particularly in electric vehicles (EVs) by reducing unnecessary energy consumption for heating and cooling subsystems.

Moreover, by reducing the number of individual components, such as separate valves, conduits, and wiring harnesses, the overall complexity of the thermal management system (200) is significantly minimized. This makes the valve easier to integrate, assemble, and maintain.

The valve (100) for the system (200) is a multi-functional unit that incorporates plurality of sections, each facilitating a plurality of pathways for coolant flow. This enables efficient distribution and regulation of coolant between various vehicle components, optimizing thermal management while reducing system complexity.

The valve (100) aids in operational flexibility by dynamically adjusting coolant flow pathways based on real-time vehicle operating conditions. Through precise actuation, the valve (100) configures fluid routing to achieve rapid thermal response under varying ambient and load scenarios. In cold climate conditions, the valve (100) facilitates accelerated heating by directing coolant flow to critical components, ensuring efficient heat distribution. Conversely, during high-load operating conditions, the valve (100) optimizes cooling, regulating thermal exchange between the electric powertrain (201), the battery (203), the radiator (202), and the refrigerant chiller (205) to prevent thermal overload and maintain system efficiency. This adaptive control ensures that each component within the system (200) receive precise and required cooling or heating, enhancing overall vehicle performance and energy efficiency.

The valve (100) structure facilitates in requiring reduced maintenance and servicing of the thermal management system (200) making this cost-effective. Further, ease of accessing the valve (100), inspection, and replacement is improved.

It is intended that the disclosure and examples be considered as exemplary only, with a true scope of disclosed embodiments being indicated by the following claims.

We claim:

1. A valve (100) for an integrated thermal management system (200) of a vehicle, the valve (100) comprising:
a housing (10), defined with an opening (12), having a plurality of ports (40) formed therein;
a body (20), rotatably disposed within the opening (12), the body (20) comprising a plurality of sections (22), each section (22a, 22b22c,22d) including a plurality of passages (24) configured to define a network of fluid connections among a plurality of ports (40); and
an actuator (30), disposed within the housing (10) and coupled to the body (20), configured to selectively control the rotation of the body (20);
a plurality of sensors (50) connected to the actuator (30), and the plurality of sensors (50) coupled to the vehicle, wherein the plurality of sensors (50) is configured to detect operating conditions based on ambient temperature and vehicle operating state; and
a control unit (60), communicatively coupled with actuator (30), and the plurality of sensors (50), and the control unit (60) is configured to:
determine the ambient temperature and the vehicle operating state based on inputs received from the plurality of sensors (50);
activate the actuator (30) to rotate the body (20) and establish the fluid connections between selected ports among the plurality of ports (40), based on real time operating conditions derived from the ambient temperature and vehicle operational state.

2. The valve (100) as claimed in claim 1, wherein the plurality of ports (40) comprises:
a plurality of inlet ports (40a) to receive a coolant from a plurality of components of a thermal management system (200), wherein each inlet port of the plurality of inlet ports (40a) is in fluid communication with at least one of an electric powertrain (201), a radiator (202), a battery (203), and a cabin heater (204), of the thermal management system (200) to receive the coolant; and
a plurality of outlet ports (40b) to direct and supply the coolant to the plurality of components of the thermal management system (200), wherein each outlet port of the plurality of outlet ports (40b) is in fluid communication with at least one of the radiator (202), a refrigerant chiller (205) for the battery (203), the electric powertrain (201), and a water heater (207) of the thermal management system (200).

3. The valve (100) as claimed in claim 2, wherein the plurality of inlet ports (40a) and the plurality of outlet ports (40b) comprise:
a first inlet port (41) to receive the coolant from the electric powertrain (201) of the vehicle;
a second inlet port (43) to receive the coolant from the radiator (202) of the vehicle;
a third inlet port (45) to receive the coolant from the battery (203) of the vehicle;
a fourth inlet port (47) to receive the coolant from the cabin heater (204) of the vehicle;
a first outlet port (42) to direct and supply the coolant to the radiator (202);
a second outlet port (44) to direct and supply the coolant to the refrigerant chiller (205) fluidly connected to the battery (203) of the vehicle through a first pump (210);
a third outlet port (46) to direct and supply the coolant to the electric powertrain (201) through a second pump (212); and
a fourth outlet port (48) to direct and supply the coolant to the water heater (207) fluidly connected to the cabin heater (204) of the vehicle through a third pump (213).

4. The valve (100) as claimed in claim 3, wherein the operating conditions comprise a first operating condition with the ambient temperature in range of −20 °C to 0 °C and the vehicle operational state is in at least one of a charging and stationary state, wherein in the first operating condition the control unit is configured to:
activate the actuator (30) to rotate the body (20) to position a first section (22a) of the plurality of (22) to align with the plurality of ports (40) to establish fluid connections between the third inlet port (45) to the fourth outlet port (48); and the fourth inlet port (47) to the second outlet port, to heat the battery (203) and the cabin heater (204) using the water heater (207), when the refrigerant chiller (205) is turned off.

5. The valve (100) as claimed in claim 4, wherein the operating conditions comprise a second operating condition with the ambient temperature in range of −20 °C to 0C and the vehicle operational state in a running state with temperature of the electric powertrain (201) nearly 80C, wherein in the second operating condition the control unit is configured to:
activate the actuator (30) to rotate the body (20) to position the first section (22a) for establishing fluid connections between the first inlet port (41) with the third outlet port (46); the third inlet port (45) with the fourth outlet port (48), and; the fourth inlet port (47) with the second outlet port, for heating of the battery (203) and the cabin heater (204) using the water heater (207), and for recirculation of the coolant within the electric powertrain (201), when the refrigerant chiller (205) is turned off.

6. The valve (100) as claimed in claim 3, wherein the operating conditions comprise a third operating condition with the ambient temperature in range of −20°C to 0°C and the vehicle operational state in a running state with temperature of the electric powertrain (201) nearly 80°C, wherein in the third operating condition the control unit is configured to:
activate the actuator (30) to rotate the body (20) to position a second section (22b) of the plurality of section (22) to align with the plurality of ports (40) for establishing fluid connections between; the first inlet port (41) and the second inlet port (43) with the second outlet port (44); the fourth inlet port (47) with the fourth outlet port (48) and; the third inlet port (45) with the third outlet port (46) to heat the battery (203) by supplying the coolant from the electric powertrain (201), and to heat the cabin heater (204) by the water heater (207), when the refrigerant chiller (205) is turned off.

7. The valve (100) as claimed in claim 3, wherein the operating conditions comprise a fourth operating condition with the ambient temperature in range of 0°C to 20°C, wherein in the fourth operating condition the control unit is configured to
activate the actuator (30) to rotate the body (20) to position a third section (22c) of the plurality of section (22) to align with the plurality of ports (40) for establishing fluid connections between:
the first inlet port (41) with the first outlet port (42),
the second inlet port (43) with the second outlet port (44),
the third inlet port (45) to the third outlet port (46), and
the fourth inlet port (47) to the fourth outlet port (48), facilitating the cooling of the battery (203) and the electric powertrain (201) by the radiator (202), and heating of the cabin heater (204) by the water heater (207) when the refrigerant chiller (205) is turned off.

8. The valve (100) as claimed in claim 6, wherein the operating conditions comprise a fifth operating condition with the ambient temperature more than 20 °C, the vehicle operational state in a running state with temperature of the battery (203) nearly 40 °C, wherein in the fifth operating condition the control unit is configured to:
activate the actuator (30) to rotate the body (20) to the second section (22b) for establishing fluid connections between:
the first inlet port (41) and the second inlet port (43) to the second outlet port,
the fourth inlet port (47) to the fourth outlet port (48), and
the third inlet port (45) to the third outlet port (46), to cool the battery (203) and the electric powertrain (201) by the refrigerant chiller (205), and cooling of a cabin of the vehicle by supplying the refrigerant from an evaporator (206), when the third pump (213) is turned off.

9. The valve (100) as claimed in claim 3, wherein the operating conditions comprise a sixth operating condition with the ambient temperature more than 20 °C, the vehicle operational state in a running state with temperature of the battery (203) nearly 40 °C, wherein in the sixth operating condition the control unit is configured to:
activate the actuator (30) to rotate the body (20) to position a fourth section (22d) of the plurality of section (22) to align with the plurality of ports (40) for establishing fluid connections between:
the first inlet port (41) to the first outlet port (42),
the second inlet port (43) to the third outlet port (46),
the third inlet port (45) to the second outlet port, and
the fourth inlet port (47) to the fourth outlet port (48), to cool the electric powertrain (201) by the radiator (202), cool the battery (203) by the refrigerant chiller (205), and to cool the cabin of the vehicle by supplying refrigerant from the evaporator (206), when the third pump (213) is turned off.

10. An integrated thermal management system for a vehicle, comprising:
a valve (100) comprising:
a housing (10), defined with an opening (12), having a plurality of ports (40) formed therein;
a body (20), rotatably disposed within the opening (12), the body (20) comprising a plurality of sections (22), each section (22a, 22b22c,22d) including a plurality of passages (24) configured to define a network of fluid connections among a plurality of ports (40); and
an actuator (30), disposed within the housing (10) and coupled to the body (20), configured to selectively control the rotation of the body (20);
a plurality of sensors (50) connected to the actuator (30), and the plurality of sensors (50) coupled to the vehicle, wherein the plurality of sensors (50) is configured to detect operating conditions based on ambient temperature and vehicle operating state
a control unit (60), communicatively coupled with actuator (30), and the plurality of sensors (50), and the control unit (60) is configured to:
determine the ambient temperature and the vehicle operating state based on inputs received from the plurality of sensors (50);
activate the actuator (30) to rotate the body (20) and establish the fluid connections between selected ports among the plurality of ports

(40) based on real time operating conditions derived from the ambient temperature and vehicle operational state.
